(19) United States
(12) Patent Application Publication
(10) Pub. No.: US 2017/0155567 A1
(43) Pub. Date: Jun. 1, 2017

(54) METHOD AND DEVICE FOR DETECTING HOTLINKING

(71) Applicants: Le Holdings (Beijing) Co., Ltd., Beijing (CN); LeCloud Computing Co., Ltd., Beijing (CN)

(72) Inventors: Fan WEI, Beijing (CN); Ming LI, Beijing (CN)

(21) Appl. No.: 15/245,205

(22) Filed: Aug. 24, 2016

Related U.S. Application Data
(63) Continuation of application No. PCT/CN2016/082826, filed on May 20, 2016.

(30) Foreign Application Priority Data
Nov. 30, 2015 (CN) 201510856256.7

(51) Int. Cl. H04L 12/26; H04L 29/12; H04L 29/06; H04L 12/24

(52) U.S. Cl. CPC H04L 43/0894; H04L 43/16; H04L 41/0681; H04L 61/6095; H04L 63/10

(57) ABSTRACT

Disclosed are a method and a device for detecting hotlinking. The method includes: receiving a resource obtaining request sent by a client, the resource obtaining request comprising the client's IP address information; then performing statistic on processing status information corresponding to the resource obtaining request within a preset territorial scope corresponding to the IP address information; and outputting alarm information if the processing status information is not available in preset condition.

### CROSS-REFERENCE TO RELATED APPLICATIONS

This application is a continuation of International Application No. PCT/CN2016/082826, with an international filing date of May 20, 2016, which is based upon and claims priority to Chinese Patent Application No. 201510856256.7, filed on Nov. 30, 2015, the entire contents of which are incorporated herein by reference.

### TECHNICAL FIELD

The present disclosure generally relates to information technologies, and more particularly, to a method and a device for detecting hotlinking.

### BACKGROUND

With constant development of information technologies, users in application networking increasingly grow and users may obtain various required resources via the network. Consequently, more and more network security problems appear. Hotlinking is one of relatively common security problems. Hotlinking specifically is such a problem that when a server receives a resource request sent by a user, the resource request likely is duplicated by a malicious third party or an illegal operation user, and then the malicious third party or the illegal operation user simultaneously distributes the duplicated resource request to multiple illegal users so that these illegal user also can access resources in websites, thereby causing waste of website resources.

At present, since users using resources are distributed in relatively dispersive and wide regions, it is impossible to perform statistic and synchronization on all resource obtaining requests, and thus it is impossible to implement hotlinking detection, thereby causing loss of website data resources and waste of system resources.

### SUMMARY

The present disclosure provides a method and a device for detecting hotlinking to solve a problem that the prior art is unable to achieve detection of hotlinking thereby causing loss of website data resources and waste of system resources.

In a first aspect, embodiments of the present disclosure provide a method for detecting hotlinking by a resource server, including:

receiving a resource obtaining request sent by a client, the resource obtaining request comprising the client's IP address information;

within a preset territorial scope corresponding to the IP address information, performing statistic on processing status information corresponding to the resource obtaining request; and

outputting alarm information if the processing status information is not available in preset condition.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for detecting hotlinking mentioned by embodiments of the present disclosure.

In a third aspect, embodiments of the present disclosure provide a non-transitory computer-readable storage medium storing executable instructions that, when executed by an electronic device, cause the electronic device to perform any methods for detecting hotlinking mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for detecting hotlinking in accordance with some embodiments;

FIG. 2 is a flowchart of another method for detecting hotlinking in accordance with some embodiments;

FIG. 3 is a block diagram showing structural composition of a device for detecting hotlinking in accordance with some embodiments;

FIG. 4 is a block diagram showing structural composition of another device for detecting hotlinking in accordance with some embodiments; and

FIG. 5 is a block diagram showing structural composition of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

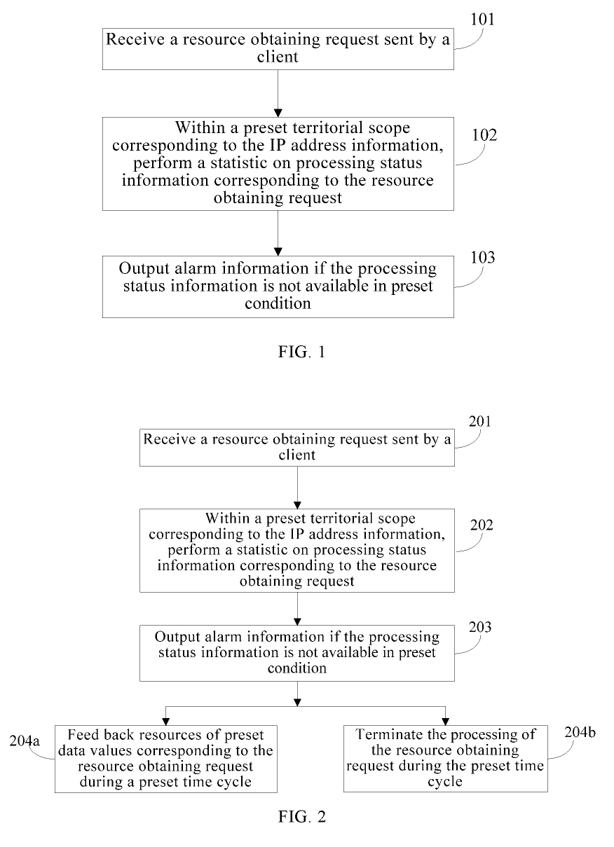

Embodiments of the present disclosure provide a method for detecting hotlinking, as shown in FIG. 1, the method may be applied to a server and specifically includes following steps:

101: Receiving, by a resource server, a resource obtaining request sent by a client.

The resource obtaining request comprises the client's IP address information. Since a communication port is required for interaction between the client and a resource server, a resource obtaining request sent by each client carries an IP address of the communication port. The resource obtaining request may also comprise identification information of resources required to be obtained so that the resource server obtains corresponding resources according to the identification information of resources and feeds back the corresponding resources to a server.

102: Within a preset territorial scope corresponding to the IP address information, performing a statistic on processing status information corresponding to the resource obtaining request.

The preset territorial scope is divided in advance according to different regions. For example, the territorial scope of Beijing Municipality may be divided according to different districts, namely, different preset territorial scopes correspond to different districts. The territorial scope of China may be divided according to provinces, which is not limited in embodiments of the present disclosure. The processing status information specifically may be the number of times of the resource obtaining request being received within a certain period of time, and bandwidth traffic consumed by the resource obtaining request within a certain period of time or the like, which is not limited in embodiments of the present disclosure. In embodiments of the present disclosure, a practical geographical location area where the client is can be obtained by parsing IP address information. Therefore, the preset territorial scope corresponding to the client can be obtained through the IP address information.

103: Outputting alarm information if the processing status information is not available in preset condition.

The preset condition varies with statistical processing status information. The preset condition may be whether a request frequency of the resource obtaining request is greater than or equal to a preset frequency threshold, or may be whether bandwidth consumption of the resource obtaining request within a certain period of time is greater than or equal to a preset threshold and so on, which is not limited in embodiments of the present disclosure. The alarm information may be text information, audio information, video information or the like, which is not limited in the embodiments of the present disclosure. For example, when the alarm information is text information, text prompt information of hotlinking presence may be displayed; when the alarm information is audio information, audio prompt information of hotlinking presence may be played; and when the alarm information is video information, flash video prompt information may be played.

In embodiments of the present disclosure, alarm information is outputted when processing status information corresponding to a resource obtaining request does not meet the preset condition, so that it is implemented to discover timely and report hotlinking and the hotlinking may be processed timely, thereby avoiding loss of website data resources and waste of system resources.

Embodiments of the present disclosure provide a method for detecting hotlinking. First of all, receive a resource obtaining request sent by a client, wherein the resource obtaining request comprises the client's IP address information; then within a preset territorial scope corresponding to the IP address information, perform statistic on processing status information corresponding to the resource obtaining request; and output alarm information if the processing status information is not available in preset condition. Compared with the fact that at present since users using resources are distributed in relatively dispersive and wide regions, it is impossible to perform statistic and synchronization on all resource obtaining requests, in embodiments of the present disclosure, it is performed synchronization and statistic on processing status information corresponding to resource obtaining requests within a certain region, and it is implemented a hotlinking detection by detecting whether an exception exists in the processing status information, thereby avoiding loss of website data resources and waste of system resources.

Corresponding to the foregoing method, embodiments of the present disclosure further provide a method for detecting hotlinking, as shown in FIG. 2, the method may be applied to a resource server and specifically includes following steps:

201: Receiving, by a resource server, a resource obtaining request sent by a client.

The resource obtaining request comprises the client's IP address information. Since a communication port is required for interaction between the client and a resource server, a resource obtaining request sent by each client comprises an IP address of the communication port. The resource obtaining request may also comprise identification information of resources required to be obtained so that the resource server obtains corresponding resources according to the identification information of resources and feeds back the corresponding resources to a server.

202: Within a preset territorial scope corresponding to the IP address information, performing a statistic on processing status information corresponding to the resource obtaining request.

The preset territorial scope is divided in advance according to different regions. For example, the territorial scope of Chaoyang District may be divided according to communities, namely, different preset territorial scopes correspond to different communities. The territorial scope of Jiangsu Province may be divided according to cities, which is not limited in embodiments of the present disclosure. The processing status information specifically may be the number of times of the resource obtaining request being received within a certain period of time, for example, the request is received 100 times in one minute; and the processing status information also may be bandwidth traffic consumed by the resource obtaining request within a certain period of time, for example, 100M bandwidth is consumed in one minute, which is not limited in embodiments of the present disclosure.

In the embodiments of the present disclosure, Step 202 may specifically include: obtaining territorial attribute information corresponding to the IP address information; performing statistic on processing status information corresponding to the resource obtaining request within a preset territorial scope corresponding to the territorial attribute information. Specifically, territorial attribute information corresponding to the IP address information may be obtained by parsing the IP address information. For example, when the IP address information is 1.202.121.215, it is parsed that territorial attribute information corresponding to the IP address information is Beijing; and when the IP address information is 1.204.134.261, it is parsed that territorial attribute information corresponding to the IP address information is Guiyang City, Guizhou Province. Each piece of territorial attribute information may correspond to one or more pieces of IP address information.

203: Outputting alarm information if the processing status information is not available in preset condition.

In the embodiments of the present disclosure, that the processing status information is not available in preset condition may be as below: the number of times of the resource obtaining request being received within a certain period of time is greater than or equal to the preset threshold, at the moment, Step 203 specifically may be that alarm information is outputted if the number of times of the resource obtaining request being received within a certain period of time is greater than or equal to the preset threshold. For example, the preset threshold for number of times in receiving the request within Chaoyang District in one minute is 10 times, but a real-time statistic shows that number of times in receiving the request in one minute is 100 times, which exceeds the preset threshold, this indicates it is apparent that the request is illegally duplicated within Chaoyang District at the moment, and thus alarm information is outputted so that this problem is processed timely.

Alternatively, that the processing status information is not available in preset condition includes: bandwidth traffic consumed by the resource obtaining request within a certain period of time being greater than or equal to a preset threshold. At the moment, Step 203 specifically may be as below: alarm information is outputted when bandwidth traffic consumed by the resource obtaining request within a certain period of time is greater than or equal to the preset threshold. For example, when what is correspondingly requested by the resource request is image resource data, bandwidth traffic generally consumed by the image resource data is 5M, namely, bandwidth traffic correspondingly consumed in a preset period of time is 5M. When bandwidth traffic actually consumed is 500M, this indicates at the moment it is apparent that the request is illegally duplicated, and thus alarm information is outputted so that the problem is timely solved. When what is correspondingly requested by the resource request is video resource data, bandwidth traffic generally consumed by the video resource data is 500M, namely, bandwidth traffic correspondingly consumed in a preset period of time is 500M. When bandwidth traffic actually consumed is 500M, this indicates at the moment the bandwidth traffic is within a normal range, and thus no alarm information is outputted. As can be seen, hotlinking detection accuracy may be further improved by configuring different preset processing status information for different resource requests, thereby avoiding unnecessary alarm.

In the embodiments of the present disclosure, alarm information is outputted when processing status information corresponding to a resource obtaining request does not meet the preset condition, so that it is implemented to discover timely and report hotlinking and the hotlinking may be processed timely, thereby avoiding loss of website data resources and waste of system resources.

204a: Feeding back resources of preset data values corresponding to the resource obtaining request during a preset time cycle.

The preset time cycle may be configured according to actual needs, to a hotlinking problem that is easy to process, the preset time cycle may be configured relatively small, whereas to a hotlinking problem that is comparatively difficult to process, the preset time cycle may be configured relatively large, which is not limited in embodiments of the present disclosure. Preset data value is data value normally fed back by a primary request. Resources of preset data values corresponding to the resource obtaining request is fed back during the preset time cycle, thereby reducing loss of website data resources and waste of system resources in the event of hotlinking. By configuring the preset time cycle, it is ensured that a normal processing mechanism may be recovered for the resource request after the problem of hotlinking is solved.

In Step 204b in parallel with Step 204a, terminating the processing of the resource obtaining request during the preset time cycle.

In the embodiments of the present disclosure, terminating the processing of the resource obtaining request during the preset time cycle specifically may include: not feeding back resources corresponding to the resource obtaining request or feeding back error prompt information to the client to prevent the client from repeatedly sending the resource obtaining request to the resource server. By terminating the processing of the resource obtaining request during the preset time cycle, it is further reduced or avoided loss of website data resources and waste of system resources in the event of hotlinking.

In the embodiments of the present disclosure, a specific application scenario may be as shown below, including but not limited to: first of all, the resource server receives a resource obtaining request sent by a client, where the resource obtaining request carries IP address information (110.102.156.12) of the client, by parsing the IP address information, it is obtained that territorial attribute information of the client is China's Inner Mongolia Autonomous Region, then it is calculated that number of times in sending the resource obtaining request within China's Inner Mongolia Autonomous Region in one minute is 10,000 times, and bandwidth traffic consumed by the resource obtaining request is 100 G However, under normal circumstances, number of times in sending the resource obtaining request in one minute is 1,000 times, and bandwidth traffic consumed is 10 G. At the moment, alarm information is outputted so that it is processed this abnormal occurrence caused by presence of hotlinking, and it is terminated to feed back resources requested by the resource obtaining request or only 10 G resources are fed back, thereby avoiding loss of web site data resources and waste of system resources.

Embodiments of the present disclosure provide another method for detecting hotlinking. First of all, receive a resource obtaining request sent by a client, where the resource obtaining request comprises the client's IP address information; then within a preset territorial scope corresponding to the IP address information, perform statistic on processing status information corresponding to the resource obtaining request; and output alarm information if the processing status information is not available in preset condition. Compared with the fact that at present since users using resources are distributed in relatively dispersive and wide regions, it is impossible to perform statistic and synchronization on all resource obtaining requests. In embodiments of the present disclosure, performing synchronization and statistic on processing status information corresponding to resource obtaining requests within a certain region, and implementing a hotlinking detection by detecting whether an exception exists in the processing status information, thereby avoid loss of website data resources and waste of system resources.

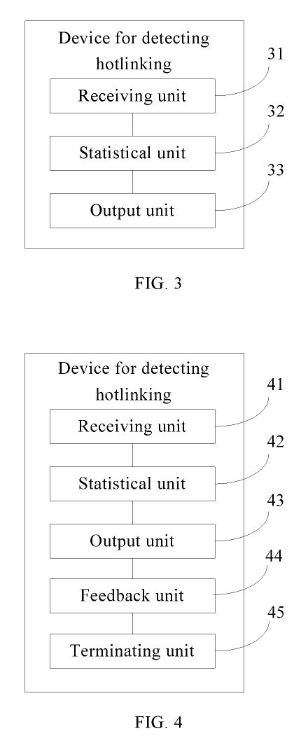

Further, as concrete implementation of the method as shown in FIG. 1, embodiments of the present disclosure provide a device for detecting hotlinking which may be disposed in a resource server, as shown in FIG. 3, the device includes: a receiving unit 31, a statistical unit 32 and an output unit 33.

The receiving unit 31 is configured to receive a resource obtaining request sent by a client, where the resource obtaining request carries IP address information of the client.

The statistical unit 32 is configured to perform statistic on processing status information corresponding to the resource obtaining request within a preset territorial scope corresponding to the IP address information.

The output unit 33 is configured to output alarm information if the processing status information is not available in preset condition.

It should be explained that reference may be made to corresponding description in FIG. 1 for other corresponding description of various function units involved with the device for detecting hotlinking provided by embodiments of the present disclosure, which is not repeated any more herein.

Embodiments of the present disclosure provide a device for detecting hotlinking. First of all, receive a resource obtaining request sent by a client, where the resource obtaining request comprises the client's IP address information; then within a preset territorial scope corresponding to the IP address information, perform statistic on processing status information corresponding to the resource obtaining request; and output alarm information if the processing status information is not available in preset condition. Compared with the fact that at present since users using resources are distributed in relatively dispersive and wide regions, it is impossible to perform statistic and synchronization on all resource obtaining requests. In embodiments of the present disclosure, performing synchronization and statistic on processing status information corresponding to resource obtaining requests within a certain region, and implementing a hotlinking detection by detecting whether an exception exists in the processing status information, thereby avoid loss of website data resources and waste of system resources.

Further, as concrete implementation of the method as shown in FIG. 2, embodiments of the present disclosure provide a device for detecting hotlinking which may be disposed in a resource server, as shown in FIG. 4, the device includes: a receiving unit 41, a statistical unit 42, an output unit 43, a feedback unit 44 and a terminating unit 45.

The receiving unit 41 is configured to receive a resource obtaining request sent by a client, where the resource obtaining request carries IP address information of the client.

The statistical unit 42 is configured to perform statistic on processing status information corresponding to the resource obtaining request within a preset territorial scope corresponding to the IP address information.

The output unit 43 is configured to output alarm information if the processing status information is not available in preset condition.

The statistical unit 42 is specifically configured to obtain territorial attribute information corresponding to the IP address information, and

perform statistic on processing status information corresponding to the resource obtaining request within a preset territorial scope corresponding to the territorial attribute information.

Further, that the processing status information is not available in preset condition includes: the number of times of the resource obtaining request being received within a certain period of time being greater than or equal to a preset threshold.

The output unit 43 is specifically configured to output alarm information when the number of times of the resource obtaining request being received within a certain period of time is greater than or equal to the preset threshold.

Further, that the processing status information is not available in preset condition includes: bandwidth traffic consumed by the resource obtaining request within a certain period of time being greater than or equal to a preset threshold.

The output unit 43 is specifically configured to output alarm information when bandwidth traffic consumed by the resource obtaining request within a certain period of time is greater than or equal to the preset threshold.

Further, the feedback unit 44 is configured to feed back resources of preset data values corresponding to the resource obtaining request during a preset time cycle.

The terminating unit 45 is configured to terminate the processing of the resource obtaining request during the preset time cycle.

It should be explained that reference may be made to corresponding description in FIG. 2 for other corresponding description of various function units involved with the device for detecting hotlinking provided by embodiments of the present disclosure, which is not repeated any more herein.

Embodiments of the present disclosure provide another device for detecting hotlinking. First of all, receive a resource obtaining request sent by a client, where the resource obtaining request comprises the client's IP address information; then within a preset territorial scope corresponding to the IP address information, perform statistic on processing status information corresponding to the resource obtaining request; and output alarm information if the processing status information is not available in preset condition. Compared with the fact that at present since users using resources are distributed in relatively dispersive and wide regions, it is impossible to perform statistic and synchronization on all resource obtaining requests. In embodiments of the present disclosure, performing synchronization and statistic on processing status information corresponding to resource obtaining requests within a certain region, and implementing a hotlinking detection by detecting whether an exception exists in the processing status information, thereby avoid loss of website data resources and waste of system resources.

Further, an embodiment of the present disclosure further provides a non-transitory computer-readable storage medium storing executable instructions, which can be executed by an electronic device to perform any methods for detecting hotlinking mentioned by embodiments of the present disclosure.

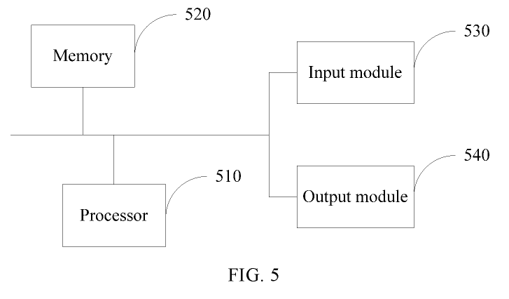

FIG. 5 is a block diagram of an electronic device which is configured to perform the methods for detecting hotlinking according to an embodiment of the present disclosure. As shown in FIG. 5, the device includes: one or more processors 510 and memory 520. A processor 510 is showed in FIG. 5 for an example.

Device which is configured to perform the methods for detecting hotlinking can also include: input module 530 and output module 540.

Processor 510, memory 520, input module 530 and output module 540 can be connected by BUS or other methods, and BUS connecting is showed in FIG. 5 for an example.

Memory 520 can be used for storing non-transitory software program, non-transitory computer executable program and modules as a non-transitory computer-readable storage medium, such as corresponding program instructions/modules for the methods for detecting hotlinking mentioned by embodiments of the present disclosure (such as shown in FIG. 3, receiving unit 31, statistical unit 32, output unit 33). Processor 510 performs kinds of functions and data processing of the electronic device by executing non-transitory software program, instructions and modules which are stored in memory 520, thereby realizes the methods for detecting hotlinking mentioned by embodiments of the present disclosure.

Memory 520 can include program storage area and data storage area, thereby the operating system and applications required by at least one function can be stored in program storage area and data created by using the device for detecting hotlinking can be stored in data storage area. Furthermore, memory 520 can include high speed Random-access memory (RAM) or non-volatile memory such as magnetic disk storage device, flash memory device or other non-volatile solid state storage devices. In some embodiments, memory 520 can include long-distance setup memories relative to processor 510, which can communicate with the device for detecting hotlinking by networks. The examples of said networks are including but not limited to Internet, Intranet, LAN, mobile Internet and their combinations.

Input module 530 can be used to receive inputted number, character information and key signals causing user configures and function controls of the device for detecting hotlinking. Output module 540 can include a display screen or a display device.

The said module or modules are stored in memory 520 and perform the methods for detecting hotlinking when executed by one or more processors 510.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The device embodiments set forth above is merely exemplary, where units described as detached parts can be or not be detachable physically; parts displayed as units can be or not be physical units, i.e., either located at the same place, or distributed on a plurality of network units. Modules may be selected in part or in whole according to actual needs to achieve objectives of the solution of this embodiment.

It can be known from the foregoing implementation modes, those skilled in the art may clearly know that various implementation modes can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (personal computers or servers, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for detecting hotlinking, implemented by a resource server, comprising:
receiving a resource obtaining request sent by a client, the resource obtaining request comprising the client's IP address information;
within a preset territorial scope corresponding to the IP address information, performing statistic on processing status information corresponding to the resource obtaining request; and
outputting alarm information if the processing status information is not available in preset condition.

2. The method according to claim 1, wherein within a preset territorial scope corresponding to the IP address information, the performing statistic on processing status information corresponding to the resource obtaining request comprises:
obtaining territorial attribute information corresponding to the IP address information; and
within a preset territorial scope corresponding to the territorial attribute information, performing statistic on processing status information corresponding to the resource obtaining request.

3. The method according to claim 1, wherein that the processing status information is not available in preset condition comprises:
the number of times of the resource obtaining request being received within a certain period of time being greater than or equal to a preset threshold, or bandwidth traffic consumed by the resource obtaining request within a certain period of time being greater than or equal to a preset threshold.

4. The method according to claim 1, wherein the alarm information is text information, audio information or video information.

5. The method according to claim 1, wherein after outputting alarm information if the processing status information is not available in preset condition, the method further comprises:
feeding back resources of preset data values corresponding to the resource obtaining request during a preset time cycle; or
terminating the processing of the resource obtaining request during the preset time cycle.

6. An electronic device, comprising:
at least one processor; and
a memory communicably connected with the at least one processor for storing instructions executable by the at least one processor, wherein execution of the instructions by the at least one processor causes the at least one processor to:
receive a resource obtaining request sent by a client, the resource obtaining request comprising the client's IP address information;
within a preset territorial scope corresponding to the IP address information, perform statistic on processing status information corresponding to the resource obtaining request; and
output alarm information if the processing status information is not available in preset condition.

7. The electronic device according to claim 6, wherein the instructions are executed to cause the at least one processor to:
obtain territorial attribute information corresponding to the IP address information, and
within a preset territorial scope corresponding to the territorial attribute information, perform statistic on processing status information corresponding to the resource obtaining request.

8. The electronic device according to claim 6, wherein that the processing status information is not available in preset condition comprises:
the number of times of the resource obtaining request being received within a certain period of time being greater than or equal to a preset threshold, or bandwidth traffic consumed by the resource obtaining request within a certain period of time being greater than or equal to a preset threshold.

9. The electronic device according to claim 6, wherein the alarm information is text information, audio information or video information.

10. The electronic device according to claim 6, wherein the instructions are executed to cause the at least one processor to:
feed back resources of preset data values corresponding to the resource obtaining request during a preset time cycle; or
terminate the processing of the resource obtaining request during the preset time cycle.

11. A non-transitory computer-readable storage medium storing executable instructions that, when executed by an electronic device, cause the electronic device to:
receive a resource obtaining request sent by a client, the resource obtaining request comprising the client's IP address information;
within a preset territorial scope corresponding to the IP address information, perform statistic on processing status information corresponding to the resource obtaining request; and
output alarm information if the processing status information is not available in preset condition.

12. The non-transitory computer-readable storage medium according to claim 11, wherein the executable instructions are executed to cause the electronic device to:
obtain territorial attribute information corresponding to the IP address information, and
within a preset territorial scope corresponding to the territorial attribute information, perform statistic on processing status information corresponding to the resource obtaining request.

13. The non-transitory computer-readable storage medium according to claim 11, wherein that the processing status information is not available in preset condition comprises:
the number of times of the resource obtaining request being received within a certain period of time being greater than or equal to a preset threshold, or bandwidth traffic consumed by the resource obtaining request within a certain period of time being greater than or equal to a preset threshold.

14. The non-transitory computer-readable storage medium according to claim 11, wherein the alarm information is text information, audio information or video information.

15. The non-transitory computer-readable storage medium according to claim 11, wherein the executable instructions are executed to cause the electronic device to:
feed back resources of preset data values corresponding to the resource obtaining request during a preset time cycle; or
terminate the processing of the resource obtaining request during the preset time cycle.
